(19) United States
(12) Patent Application Publication
(10) Pub. No.: US 2025/0316939 A1
(43) Pub. Date: Oct. 9, 2025

(54) TRAVEL ADAPTER

(71) Applicant: Huizhou Ouli Technology Co., Ltd., Huizhou (CN)

(72) Inventor: Song Liu, Huizhou (CN)

(21) Appl. No.: 19/098,984

(22) Filed: Apr. 3, 2025

(30) Foreign Application Priority Data
Apr. 8, 2024 (CN) 202410413122.7

(51) Int. Cl. H01R 31/06; H01R 13/04; H01R 13/426; H01R 13/502

(52) U.S. Cl. CPC H01R 31/06; H01R 13/04; H01R 13/426; H01R 13/502

(57) ABSTRACT

A travel adapter is disclosed, which includes a housing and first standard plug pins and second standard plug pins mounted to the housing, the first standard plug pins including a first live wire plug pin, a first neutral wire plug pin, and a ground plug pin, the second standard plug pins including a plug sleeve slidably mounted to the housing in a Z-axis direction, where the first live wire plug pin and the first neutral wire plug pin are located on a first side of the plug sleeve, and the ground plug pin is located on a second side of the plug sleeve opposite to the first side. The travel adapter provided in the present application has the feature of compact structure.

### CROSS-REFERENCE TO RELATED APPLICATIONS

This application claims priority to Chinese Patent Application No. 202410413122.7, filed on Apr. 8, 2024, the content of which is incorporated herein by reference in its entirety.

### TECHNICAL FIELD

The present application relates to a travel adapter.

### BACKGROUND

Since different specifications of plugs and sockets in different countries are not universal in use, if one plug needs to be inserted into one socket having a mismatched specification, it is necessary to use a travel adapter. The travel adapter is a throw-over tool that can be adapted in use by inserting the travel adapter into a target socket and then inserting a target plug into a matched socket aperture in the travel adapter. The emergence of travel adapters has significantly improved the convenience of people's lives while traveling, especially during international trips, without worrying about the inconvenience of having a portable electronic device with a plug that does not fit into a local power socket.

However, the commonly used travel adapters with first standard plug pins and second standard plug pins occupy a certain space separately in the interior of the travel adapter, and two separate occupied areas are formed on the outside of the housing of the travel adapter at positions corresponding to the first standard plug pins and second standard plug pins, as shown in FIG. 1, the first standard plug pins and second standard plug pins are spaced apart in a length direction of the housing, and an overall length of the housing is relatively long, resulting in a relatively large overall volume of the travel adapter.

### SUMMARY

The technical problem to be solved by the present application is to provide a compactly configured travel adapter.

In order to solve the above-mentioned technical problem, a technical solution adopted in the present application is: a travel adapter including a housing and first standard plug pins and second standard plug pins mounted to the housing, the first standard plug pins including a first live wire plug pin, a first neutral wire plug pin, and a ground plug pin, the second standard plug pins including a plug sleeve slidably mounted to the housing in a Z-axis direction, where the first live wire plug pin and the first neutral wire plug pin are located on a first side of the plug sleeve, and the ground plug pin is located on a second side of the plug sleeve opposite to the first side; the second standard plug pin further includes a push tab, a support and a telescopic assembly, the support is provided with a second live wire plug pin and a second neutral wire plug pin, the push tab is connected to the plug sleeve, the support is slidably mounted on the plug sleeve, and the telescopic assembly is connected to the housing and the support; and when the push tab is flipped to drive the plug sleeve to slide out of the housing, the telescopic assembly drives the support to slide in the plug sleeve, such that the second live wire plug pin and the second neutral wire plug pin slide out of the plug sleeve.

Further, the telescopic assembly includes a fixing rod, a first rocker and a second rocker hingedly connected successively, one end of the fixing rod away from the first rocker is fixed to the housing, one end of the second rocker away from the first rocker is hinged to the support, the plug sleeve is provided with a driving chute, one end of the first rocker away from the fixing rod is provided with a driving protrusion, and the driving protrusion is slidably mounted on the driving chute; when the plug sleeve slides out of the housing, the driving protrusion slides from a first end of the driving chute to a second end of the driving chute, an included angle between the first rocker and the second rocker increases, and the second rocker pushes the support to slide in the plug sleeve.

Further, the telescopic assembly includes a first rack, a second rack, and a gear; the gear is rotatably mounted within the plug sleeve, the first rack is mounted within the housing and extends in a sliding direction of the plug sleeve, the second rack is mounted to the sleeve support and extends in the sliding direction of the plug sleeve, and the first rack and the second rack are engaged on opposite sides of the gear.

Further, the push tab includes a handle and a strut connected, the handle is located outside the housing, the strut is slidably mounted on the plug sleeve in an X-axis direction, a first limiting protrusion is provided on the strut, a first limiting portion extending in the Z-axis direction is provided in the housing, the first limiting portion is provided with a first limiting groove and a second limiting groove, and when the second live wire plug pin and the second neutral wire plug pin extend out of the plug sleeve, the first limiting protrusion abuts against and within the first limiting groove; and when the second live wire plug pin and the second neutral wire plug pin are received in the plug sleeve, the first limiting protrusion abuts against and within the second limiting groove.

Further, the push tab is further provided with a second limiting portion extending in the Z-axis direction, the second limiting portion being connected to the strut; the second limiting portion is provided with a third limiting groove and a fourth limiting groove, and the support is provided with a second limiting protrusion; when the second live wire plug pin and the second neutral wire plug pin extend out of the plug sleeve, the second limiting protrusion abuts against and within the third limiting groove; and when the second live wire plug pin and the second neutral wire plug pin are received in the plug sleeve, the second limiting protrusion abuts against and within the fourth limiting groove.

Further, the support is provided with an avoidance hole for avoiding the second limiting portion.

Further, the end of the strut away from the handle is sleeved with a compression spring, and the compression spring is connected to the plug sleeve.

Further, an outside wall of the plug sleeve is further provided with an avoidance groove extending in the Z-axis direction, and at least a portion of the first limiting portion is located within the avoidance groove.

Further, a guide slide extending in the Z-axis direction is provided within the housing, and the plug sleeve is slidably mounted to the guide slide.

The beneficial effects of the present application are: the travel adapter provided in the present application has the feature of compact structure. By arranging the first live wire plug pin and the first neutral wire plug pin of the first standard plug pin on the first side of the plug sleeve and arranging the ground plug pin on the second side of the plug sleeve, the space occupied by the first standard plug pin on the housing coincides with the space occupied by the second standard plug pin on the housing, reducing an overall length of the housing, reducing an overall volume of a product, and facilitating development of miniaturization of the product.

### BRIEF DESCRIPTION OF THE DRAWINGS

FIG. 1 is a schematic structural diagram of a travel adapter in the prior art;

FIG. 2 is a schematic structural diagram of a travel adapter according to an embodiment of the present application;

FIG. 3 is a cross-sectional view of a travel adapter according to an embodiment of the present application;

FIG. 4 is an exploded view of a travel adapter according to an embodiment of the present application;

FIG. 5 is an exploded view of another perspective of a travel adapter according to an embodiment of the present application; and

FIG. 6 is a schematic structural cross-sectional view of a travel adapter according to an embodiment of the present application.

### DESCRIPTION OF REFERENCE NUMERALS

1. housing; 11. upper housing; 111. upper support; 1111. first rack; 112. buffer; 12. lower housing; 121. lower support; 122. first limiting portion; 1221. first limiting groove; 1222. second limiting groove; 123. guide slide; 2. first standard plug pin; 21. first live wire plug pin; 22. first neutral wire plug pin; 23. ground plug pin; 3. push tab; 31. handle; 32. strut; 321. first limiting protrusion; 322. compression spring; 33. second limiting portion; 331. third limiting groove; 332. fourth limiting groove; 4. plug sleeve; 41. driving chute; 411. first end; 412. second end; 42. avoidance groove; 43. gear; 5. fixing rod; 6. first rocker; 61. driving protrusion; 611. bearing; 7. second rocker; 71. buffer portion; 8. support; 81. second limiting protrusion; 82. avoidance hole; 83. second live wire plug pin; 84. second neutral wire plug pin; 85. second rack.

### DETAILED DESCRIPTION OF THE EMBODIMENTS

In order to explain the technical contents, the objects, and the effects of the present application in detail, the embodiments will be described below referring to the accompanying drawings.

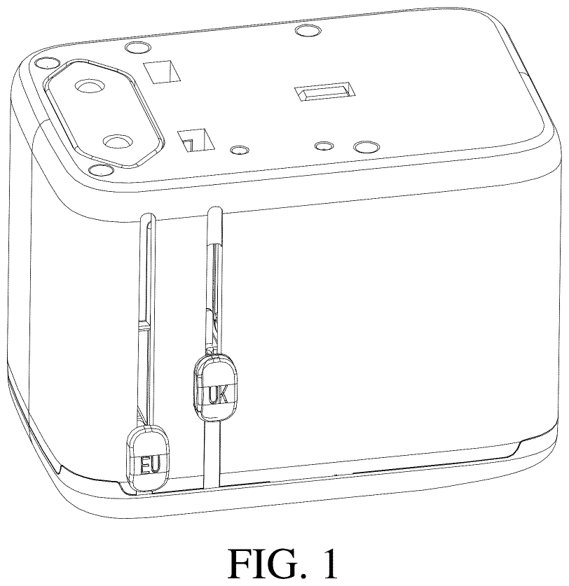

Referring to FIGS. 1 to 6, a travel adapter includes a housing 1 and first standard plug pins 2 and second standard plug pins mounted to the housing 1, the first standard plug pins 2 including a first live plug pin 21, a first neutral wire plug pin 22 and a ground plug pin 23, the second standard plug pin including a plug sleeve 4 slidably mounted to the housing 1 in a Z-axis direction; where the first live plug pin 21 and the first neutral wire plug pin 22 are located on a first side of the plug sleeve 4, and the ground plug pin 23 is located on a second side of the plug sleeve 4 opposite to the first side; the second standard plug pin further includes a push tab 3, a support 8 and a telescopic assembly, the support 8 is provided with a second live wire plug pin 83 and a second neutral wire plug pin 84, the push tab 3 is connected to the plug sleeve 4, the support 8 is slidably mounted on the plug sleeve 4, and the telescopic assembly is connected to the housing 1 and the support 8; and when the push tab 3 is flipped to drive the plug sleeve 4 out of the housing 1, the telescopic assembly drives the support 8 to slide in the plug sleeve 4, such that the second live wire plug pin 83 and the second neutral wire plug pin 84 slide out of the plug sleeve 4.

It can be seen from the above-mentioned description that the beneficial effects of the present application are: by arranging the first live wire plug pin 21 and the first neutral wire plug pin 22 of the first standard plug pin 2 on the first side of the plug sleeve 4 and arranging the ground plug pin 23 on the second side of the plug sleeve 4, the space occupied by the first standard plug pin 2 on the housing 1 coincides with the space occupied by the second standard plug pin on the housing 1, reducing an overall length of the housing 1, reducing an overall volume of a product, and facilitating development of miniaturization of the product.

Further, the telescopic assembly includes a fixing rod 5, a first rocker 6 and a second rocker 7 hingedly connected successively, one end of the fixing rod 5 away from the first rocker 6 is fixed to the housing 1, one end of the second rocker 7 away from the first rocker 6 is hinged to the support 8, the plug sleeve 4 is provided with a driving chute 41, one end of the first rocker 6 away from the fixing rod 5 is provided with a driving protrusion 61, and the driving protrusion 61 can be slidably mounted on the driving chute 41; when the plug sleeve 4 slides out from the housing 1, the driving protrusion 61 slides from a first end 411 of the driving chute 41 to a second end 412 of the driving chute 41, an included angle between the first rocker 6 and the second rocker 7 increases, and the second rocker 7 pushes the support 8 to slide in the plug sleeve 4.

It can be seen from the above-mentioned description that by pushing the push tab 3 to move so as to make the plug sleeve 4 extend out of the housing 1, and at the same time, the driving chute 41 extending through the plug sleeve 4 cooperates with the driving protrusion 61 on the first rocker 6, such that the included angle between the first rocker 6 and the second rocker 7 increases, and then the support 8 can generate two sections of displacement while the plug sleeve 4 moves, i.e., the push tab 3 moves for one section of stroke, and the support 8 can obtain two sections of stroke; it can be seen that the stroke of the push tab 3 can also be set to be shorter by pushing out the plug sleeve 4, the second live wire plug pin 83 and the second neutral wire plug pin 84, reducing a proportion of a height space in the housing 1 when the push tab 3 is movable; since the telescopic stroke of the traditional second standard plug pin is long, the second standard plug pin needs to be set away from the area where the first standard plug pin 2 is located, and the above-mentioned telescopic assembly can effectively reduce the movable stroke of the push tab 3 of the second standard plug pin, such that the second standard plug pin does not need to avoid the first standard plug pin 2, and the second standard plug pin is set in an area where the first standard plug pin 2 is located, greatly improving the space utilization rate.

Further, the telescopic assembly includes a first rack 1111, a second rack 85 and a gear 43, the gear 43 is rotatably mounted within the plug sleeve 4, the first rack 1111 is mounted within the housing 1 and extends in a sliding direction of the plug sleeve 4, the second rack 85 is mounted in the Euro-holder 8 and extends in the sliding direction of the plug sleeve 4, and the first rack 1111 and the second rack 85 are engaged on opposite sides of the gear 43.

It can be seen from the above-mentioned description that a first stage of stroke is achieved by pushing the push tab 3 to move, such that the plug sleeve 4 extends out of the housing 1, and in this process, the first rack 1111 drives the gear 43 to rotate, and the support 8 is driven to slide in the plug sleeve 4 via the engagement of the gear 43 and the second rack 85 so as to achieve a second stage of stroke, such that the second live wire plug pin 83 and the second neutral wire plug pin 84 on the support 8 extend out of the plug sleeve 4; it can be seen that the stroke of the push tab 3 can also be set to be shorter by pushing out the plug sleeve 4, the second live wire plug pin 83 and the second neutral wire plug pin 84, reducing a proportion of a height space in the housing 1 when the push tab 3 is movable; since the telescopic stroke of the traditional second standard plug pin is long, the second standard plug pin needs to be set away from the area where the first standard plug pin 2 is located, and the above-mentioned telescopic assembly can effectively reduce the movable stroke of the push tab 3 of the second standard plug pin, such that the second standard plug pin does not need to avoid the first standard plug pin 2, and the second standard plug pin is set in an area where the first standard plug pin 2 is located, greatly improving the space utilization rate.

Further, the push tab 3 includes a handle 31 and a strut 32 connected, the handle 31 is located outside the housing 1, the strut 32 is slidably mounted on the plug sleeve 4 in an X-axis direction, a first limiting protrusion 321 is provided on the strut 32, a first limiting portion 122 extending in the Z-axis direction is provided in the housing 1, the first limiting portion 122 is provided with a first limiting groove 1221 and a second limiting groove 1222, and when the second live wire plug pin 83 and the second neutral wire plug pin 84 extend out of the plug sleeve 4, the first limiting protrusion 321 abuts against and within the first limiting groove 1221; and when the second live wire plug pin 83 and the second neutral wire plug pin 84 are received in the plug sleeve 4, the first limiting protrusion 321 abuts against and within the second limiting groove 1222.

It can be seen from the above-mentioned description that the handle 31 is used for a user to operate the push tab 3, and the two limit positions of the plug sleeve 4 when the housing 1 moves can be locked by the cooperation of the first limiting protrusion 321 with the first limiting portion 122, i.e., when the first limiting protrusion 321 abuts against and within the first limiting groove 1221, the plug sleeve 4 can be prevented from being loosened when fully retracted into the housing 1; when the first limiting protrusion 321 is in contact with the second limiting groove 1222, the plug sleeve 4 can be prevented from being loosened when the plug sleeve 4 completely extends out of the housing 1; when it is necessary to extend and retract the plug sleeve 4, it is only necessary to press the handle 31 such that the first limiting protrusion 321 is disengaged from the first limiting portion 122.

Further, the push tab 3 is further provided with a second limiting portion 33 extending in the Z-axis direction, the second limiting portion 33 being connected to the strut 32; the second limiting portion 33 is provided with a third limiting groove 331 and a fourth limiting groove 332, and the support 8 is provided with a second limiting protrusion 81; when the second live wire plug pin 83 and the second neutral wire plug pin 84 extend out of the plug sleeve 4, the second limiting protrusion 81 abuts against and within the third limiting groove 331; when the second live wire plug pin 83 and the second neutral wire plug pin 84 are received in the plug sleeve 4, the second limiting protrusion 81 abuts against and within the fourth limiting groove 332.

It can be seen from the above-mentioned description that by means of the cooperation between the second limiting protrusion 81 and the second limiting portion 33, the two limit positions of the support 8 when moving in the plug sleeve 4 can be locked, i.e., when the second limiting protrusion 81 abuts against and within the third limiting groove 331, the support 8 can be prevented from being loosened after the second live wire plug pin 83 and the second neutral wire support leg are completely retracted into the plug sleeve 4; when the second limiting protrusion 81 is in contact with the fourth limiting groove 332, the support 8 can be prevented from being loosened after the second live wire plug pin 83 and the second neutral wire support leg completely extend out of the plug sleeve 4; by pressing the handle 31, the second limiting protrusion 81 can be disengaged from the second limiting portion 33, so as to unlock the second standard plug pin.

Further, the support 8 is provided with an avoidance hole 82 for avoiding the second limiting portion 33.

It can be seen from the above-mentioned description that the avoidance hole 82 can avoid the second limiting portion 33 from interfering with the support 8.

Further, the end of the strut 32 away from the handle 31 is sleeved with a compression spring 322, and the compression spring 322 is connected to the plug sleeve 4.

It can be seen from the above-mentioned description that the compression spring 322 can provide a reverse thrust force to the strut 32, ensuring that the first limiting protrusion 321 on the strut 32 can effectively abut against the first limiting portion 122, and ensuring that the second limiting portion 33 can effectively abut against the second limiting protrusion 81.

Further, an outer side wall of the plug sleeve 4 is further provided with an avoidance groove 42 extending in the Z-axis direction, and at least a portion of the first limiting portion 122 is located within the avoidance groove 42.

It can be seen from the above-mentioned description that the avoidance groove 42 can avoid the first limiting portion 122 from interfering with the plug sleeve 4.

Further, a guide slide 123 extending in the Z-axis direction is provided within the housing 1, and the plug sleeve 4 is slidably mounted to the guide slide 123.

It can be seen from the above-mentioned description that the guide slide 123 can guide the sliding of the plug sleeve 4 in the housing 1, ensuring the stability of the movement of the plug sleeve 4.

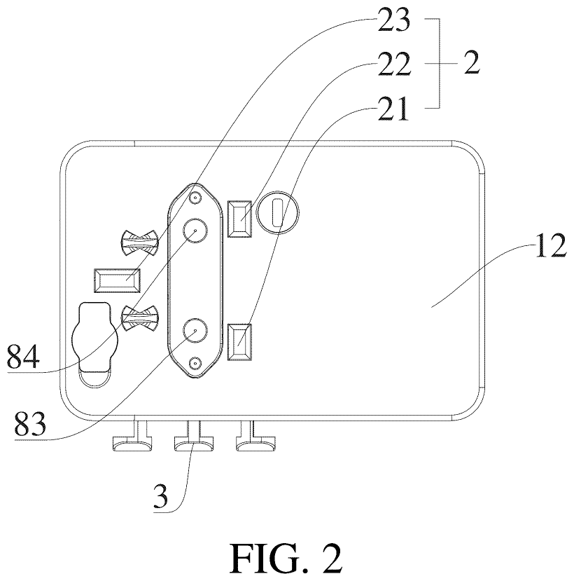

Referring to FIGS. 2 to 5, an embodiment of the present application is: a travel adapter includes a housing 1 and first standard plug pins 2 and second standard plug pins mounted to the housing 1, the first standard plug pins 2 including a first live plug pin 21, a first neutral wire plug pin 22 and a ground plug pin 23, the second standard plug pin including a plug sleeve 4 slidably mounted to the housing 1 in a Z-axis direction; where the first live plug pin 21 and the first neutral wire plug pin 22 are located on a first side of the plug sleeve 4, and the ground plug pin 23 is located on a second side of the plug sleeve 4 opposite to the first side; the second standard plug pin further includes a push tab 3, a support 8 and a telescopic assembly, the support 8 is provided with a second live wire plug pin 83 and a second neutral wire plug pin 84, the push tab 3 is connected to the plug sleeve 4, the support 8 is slidably mounted on the plug sleeve 4, and the telescopic assembly is connected to the housing 1 and the support 8; and when the push tab 3 is flipped to drive the plug sleeve 4 out of the housing 1, the telescopic assembly drives the support 8 to slide in the plug sleeve 4, such that the second live wire plug pin 83 and the second neutral wire plug pin 84 slide out of the plug sleeve 4. a travel adapter includes a housing 1 and first standard plug pins 2 and second standard plug pins mounted to the housing 1, the first standard plug pins 2 including a first live plug pin 21, a first neutral wire plug pin 22 and a ground plug pin 23, the second standard plug pin including a plug sleeve 4 slidably mounted to the housing 1 in a Z-axis direction; where the first live plug pin 21 and the first neutral wire plug pin 22 are located on a first side of the plug sleeve 4, and the ground plug pin 23 is located on a second side of the plug sleeve 4 opposite to the first side; the second standard plug pin further includes a push tab 3, a support 8 and a telescopic assembly, the support 8 is provided with a second live wire plug pin 83 and a second neutral wire plug pin 84, the push tab 3 is connected to the plug sleeve 4, the support 8 is slidably mounted on the plug sleeve 4, and the telescopic assembly is connected to the housing 1 and the support 8; and when the push tab 3 is flipped to drive the plug sleeve 4 out of the housing 1, the telescopic assembly drives the support 8 to slide in the plug sleeve 4, such that the second live wire plug pin 83 and the second neutral wire plug pin 84 slide out of the plug sleeve 4.

Preferably, the telescopic assembly includes a fixing rod 5, a first rocker 6 and a second rocker 7 hingedly connected successively, one end of the fixing rod 5 away from the first rocker 6 is fixed to the housing 1, one end of the second rocker 7 away from the first rocker 6 is hinged to the support 8, the plug sleeve 4 is provided with a driving chute 41, one end of the first rocker 6 away from the fixing rod 5 is provided with a driving protrusion 61, and the driving protrusion 61 can be slidably mounted on the driving chute 41; when the plug sleeve 4 slides out from the housing 1, the driving protrusion 61 slides from a first end 411 of the driving chute 41 to a second end 412 of the driving chute 41, an included angle between the first rocker 6 and the second rocker 7 increases, and the second rocker 7 pushes the support 8 to slide in the plug sleeve 4. By pushing the push tab 3 to move so as to make the plug sleeve 4 extend out of the housing 1, and at the same time, the driving chute 41 extending through the plug sleeve 4 cooperates with the driving protrusion 61 on the first rocker 6, such that the included angle between the first rocker 6 and the second rocker 7 increases, and then the support 8 can generate two stages of displacement while the plug sleeve 4 moves, i.e., the push tab 3 moves for one stage of stroke, and the support 8 can obtain two stages of stroke; it can be seen that the stroke of the push tab 3 can also be set to be shorter by pushing out the plug sleeve 4, the second live wire plug pin 83 and the second neutral wire plug pin 84, reducing a proportion of a height space in the housing 1 when the push tab 3 is movable; since the telescopic stroke of the traditional second standard plug pin is long, the second standard plug pin needs to be set away from the area where the first standard plug pin 2 is located, and the above-mentioned telescopic assembly can effectively reduce the movable stroke of the push tab 3 of the second standard plug pin, such that the second standard plug pin does not need to avoid the first standard plug pin 2, and the second standard plug pin is set in an area where the first standard plug pin 2 is located, greatly improving the space utilization rate.

Specifically, when the plug sleeve 4 is fully retracted into the housing 1 and the second live wire plug pin 83 and the second neutral wire plug pin 84 are fully retracted into the plug sleeve 4, the driving protrusion 61 is located at a first end 411 of the driving chute 41, and at this time, the included angle between the first rocker 6 and the second rocker 7 is the smallest; when the plug sleeve 4 is completely exposed outside the housing 1, and the second live wire plug pin 83 and the second neutral wire plug pin 84 are completely exposed outside the plug sleeve 4, the driving protrusion 61 is located at the second end 412 of the driving chute 41, and at this moment, the included angle between the first rocker 6 and the second rocker 7 is the largest; as an alternative, the included angle between the first rocker 6 and the second rocker 7 varies in a range of from 0 to 180 deg. and the maximum value of the included angle between the first rocker 6 and the second rocker 7 can be set according to actual application requirements.

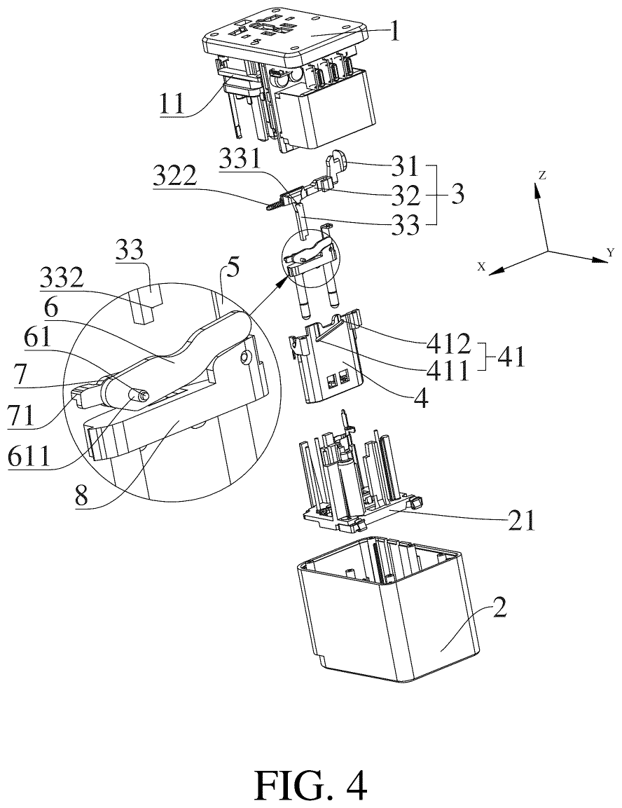

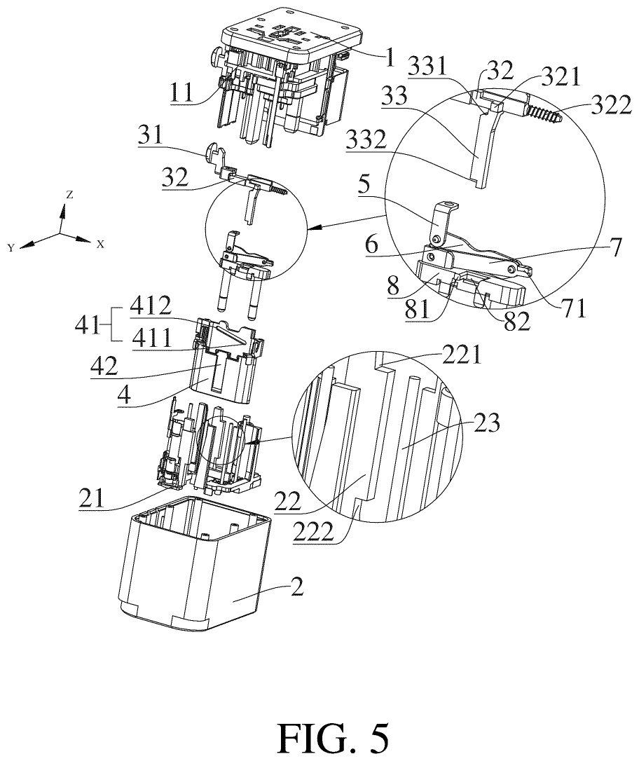

Referring to FIGS. 4 and 5, the housing 1 includes an upper housing 11 and a lower housing 12 connected to the upper housing 11, where the lower housing 12 is provided with a plug hole for the plug sleeve 4 to extend through, the upper housing 11 is provided with an upper support 111, and the lower housing 12 is provided with a lower support 121; the fixing rod 5 is mounted on the upper support 111, and specifically in the present embodiment, the fixing rod 5 is fixed to the upper support 111 by a screw; the upper support 111 is further provided with a guide slide 123 extending in the Z-axis direction, one end of the guide slide 123 away from the upper support 111 is connected to the lower support 121, and the plug sleeve 4 is slidably mounted on the guide slide 123; the guide slide 123 can guide the sliding of the plug sleeve 4 in the housing 1, and ensure the stability of the movement of the plug sleeve 4.

In addition, in some embodiments, the fixing rod 5 may also be attached to the upper support 111 by gluing, such that the assembly process is simple and the assembly difficulty is reduced. Alternatively, the fixing rod 5 may be integrally formed with the upper support 111 through an over-mold process, such that the assembly process can be omitted, and the assembly accuracy can be improved to facilitate the improvement of the yield of the product.

Preferably, the push tab 3 includes a handle 31 and a strut 32 connected, the handle 31 is located outside the housing 1, the strut 32 is slidably mounted on the plug sleeve 4 in an X-axis direction, a first limiting protrusion 321 is provided on the strut 32, a first limiting portion 122 extending in the Z-axis direction is provided in the housing 1, the first limiting portion 122 is provided with a first limiting groove 1221 and a second limiting groove 1222, and when the second live wire plug pin 83 and the second neutral wire plug pin 84 extend out of the plug sleeve 4, the first limiting protrusion 321 abuts against and within the first limiting groove 1221; and when the second live wire plug pin 83 and the second neutral wire plug pin 84 are received in the plug sleeve 4, the first limiting protrusion 321 abuts against and within the second limiting groove 1222; it can be easily understood that the handle 31 is used for a user to operate the push tab 3, and the two limit positions of the plug sleeve 4 when the housing 1 moves can be locked by the cooperation of the first limiting protrusion 321 with the first limiting portion 122, i.e., when the first limiting protrusion 321 abuts against and within the first limiting groove 1221, the plug sleeve 4 can be prevented from being loosened when fully retracted into the housing 1; when the first limiting protrusion 321 is in contact with the second limiting groove 1222, the plug sleeve 4 can be prevented from being loosened when the plug sleeve 4 completely extends out of the housing 1; when it is necessary to extend and retract the plug sleeve 4, it is only necessary to press the handle 31 such that the first limiting protrusion 321 is disengaged from the first limiting portion 122.

Specifically, the push tab 3 is further provided with a second limiting portion 33 extending in the Z-axis direction, the second limiting portion 33 being connected to the strut 32; the second limiting portion 33 is provided with a third limiting groove 331 and a fourth limiting groove 332, and the support 8 is provided with a second limiting protrusion 81; when the second live wire plug pin 83 and the second neutral wire plug pin 84 extend out of the plug sleeve 4, the second limiting protrusion 81 abuts against and within the third limiting groove 331; when the second live wire plug pin 83 and the second neutral wire plug pin 84 are received in the plug sleeve 4, the second limiting protrusion 81 abuts against and within the fourth limiting groove 332, by means of the cooperation between the second limiting protrusion 81 and the second limiting portion 33, the two limit positions of the support 8 when moving in the plug sleeve 4 can be locked, i.e., when the second limiting protrusion 81 abuts against and within the third limiting groove 331, the support 8 can be prevented from being loosened after the second live wire plug pin 83 and the second neutral wire support leg are completely retracted into the plug sleeve 4; when the second limiting protrusion 81 is in contact with the fourth limiting groove 332, the support 8 can be prevented from being loosened after the second live wire plug pin 83 and the second neutral wire support leg completely extend out of the plug sleeve 4; by pressing the handle 31, the second limiting protrusion 81 can be disengaged from the second limiting portion 33, so as to unlock the second standard plug pin; in detail, a compression spring 322 is sleeved at an end of the strut 32 away from the handle 31, the compression spring 322 is connected to the plug sleeve 4, and the compression spring 322 can provide a reverse thrust force to the strut 32, ensuring that the first limiting protrusion 321 on the strut 32 can effectively abut against the first limiting portion 122, and ensuring that the second limiting portion 33 can effectively abut against the second limiting protrusion 81.

Referring to FIG. 5, the support 8 is provided with an avoidance hole 82 for avoiding the second limiting portion 33 and the avoidance hole 82 can avoid the second limiting portion 33 from interfering with the support 8; specifically, an outer side wall of the plug sleeve 4 is further provided with an avoidance groove 42 extending in the Z-axis direction, and at least a portion of the first limiting portion 122 is located within the avoidance groove 42, and the avoidance groove 42 can prevent the first limiting portion 122 from interfering with the plug sleeve 4 and the avoidance groove 42 can avoid the first limiting portion 122 from interfering with the plug sleeve 4.

As an alternative, in some embodiments, the driving protrusion 61 is further sleeved with a bearing 611 for abutting against a side wall of the driving chute 41, and the provision of the bearing 611 on the driving protrusion 61 reduces sliding friction between the driving protrusion 61 and the side wall of the driving chute 41, so that the movement of the driving protrusion 61 within the driving chute 41 is smoother.

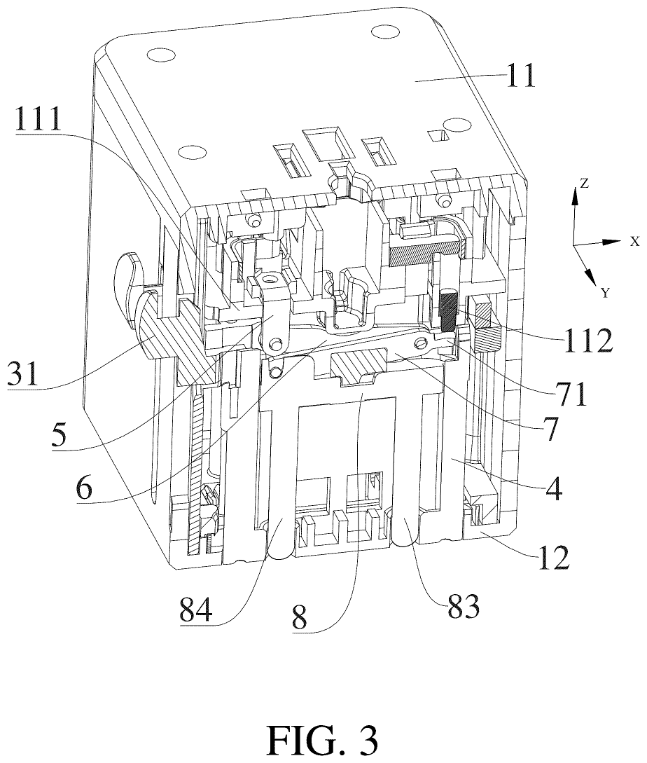

Preferably, in conjunction with FIG. 3, a buffer 112 is provided in the housing 1 and mounted on the upper support 111, one end of the second rocker 7 away from the support 8 is provided with a buffer portion 71, and when the driving protrusion 61 is located at a first end 411 of the driving chute 41, the buffer portion 71 abuts against the buffer 112, and the buffer 112 is provided to abut against the buffer portion 71 on the second rocker 7, such that the risk of damage to the second rocker 7 can be reduced; specifically, the buffer 112 may be a rubber soft pad or a glass bead screw, which can be specifically selected according to actual application requirements, and will not be described in detail herein.

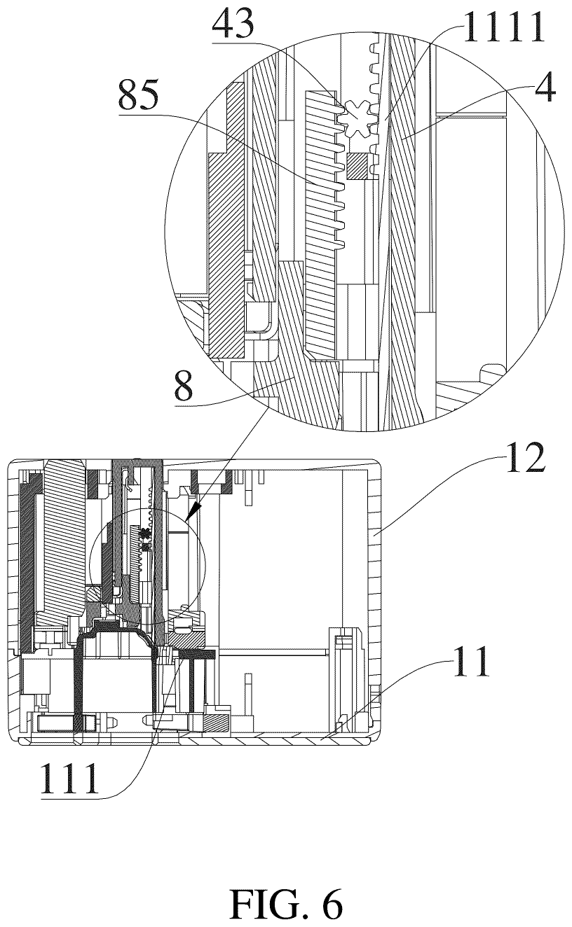

Referring to FIG. 6, in some embodiments, the telescopic assembly includes a first rack 1111, a second rack 85 and a gear 43, the gear 43 is rotatably mounted within the plug sleeve 4, the first rack 1111 is mounted within the housing 1 and extends in a sliding direction of the plug sleeve 4, the second rack 85 is mounted in the Euro-holder 8 and extends in the sliding direction of the plug sleeve 4, and the first rack 1111 and the second rack 85 are engaged on opposite sides of the gear 43; specifically, one end of the first rack 1111 is mounted to the upper support 111, and the other end of the first rack 1111 extends into the plug sleeve 4 and is engaged with the gear 43.

It can be understood that a first stage of stroke is achieved by pushing the push tab 3 to move, such that the plug sleeve 4 extends out of the housing 1, and in this process, the first rack 1111 drives the gear 43 to rotate, and the support 8 is driven to slide in the plug sleeve 4 via the engagement of the gear 43 and the second rack 85 so as to achieve a second stage of stroke, such that the second live wire plug pin 83 and the second neutral wire plug pin 84 on the support 8 extend out of the plug sleeve 4; it can be seen that the stroke of the push tab 3 can also be set to be shorter by pushing out the plug sleeve 4, the second live wire plug pin 83 and the second neutral wire plug pin 84, reducing a proportion of a height space in the housing 1 when the push tab 3 is movable; since the telescopic stroke of the traditional second standard plug pin is long, the second standard plug pin needs to be set away from the area where the first standard plug pin 2 is located, and the above-mentioned telescopic assembly can effectively reduce the movable stroke of the push tab 3 of the second standard plug pin, such that the second standard plug pin does not need to avoid the first standard plug pin 2, and the second standard plug pin is set in an area where the first standard plug pin 2 is located, greatly improving the space utilization rate.

In summary, the travel adapter provided in the present application has the feature of compact structure. By arranging the first live wire plug pin and the first neutral wire plug pin of the first standard plug pin on the first side of the plug sleeve and arranging the ground plug pin on the second side of the plug sleeve, the space occupied by the first standard plug pin on the housing coincides with the space occupied by the second standard plug pin on the housing, reducing an overall length of the housing, reducing an overall volume of a product, and facilitating development of miniaturization of the product.

The above description is merely illustrative of the embodiments of the present application and does not limit the patent protection scope of the present application, any equivalent transformations made with the description and drawings of the present application, or direct or indirect applications in related technical fields, shall similarly fall within the patent protection scope of the present application.

1. A travel adapter, comprising a housing and first standard plug pins and second standard plug pins mounted to the housing, the first standard plug pins comprising a first live wire plug pin, a first neutral wire plug pin, and a ground plug pin, the second standard plug pins comprising a plug sleeve slidably mounted to the housing in a Z-axis direction, wherein the first live wire plug pin and the first neutral wire plug pin are located on a first side of the plug sleeve, and the ground plug pin is located on a second side of the plug sleeve opposite to the first side; the second standard plug pins further comprise a push tab, a support and a telescopic assembly, the support is provided with a second live wire plug pin and a second neutral wire plug pin, the push tab is connected to the plug sleeve, the support is slidably mounted on the plug sleeve, and the telescopic assembly is connected to the housing and the support; and when the push tab is flipped to drive the plug sleeve to slide out of the housing, the telescopic assembly drives the support to slide in the plug sleeve, such that the second live wire plug pin and the second neutral wire plug pin slide out of the plug sleeve; the telescopic assembly comprises a fixing rod, a first rocker and a second rocker hingedly connected successively, one end of the fixing rod away from the first rocker is fixed to the housing, one end of the second rocker away from the first rocker is hinged to the support, the plug sleeve is provided with a driving chute, one end of the first rocker away from the fixing rod is provided with a driving protrusion, and the driving protrusion is slidably mounted on the driving chute; when the plug sleeve slides out of the housing, the driving protrusion slides from a first end of the driving chute to a second end of the driving chute, an included angle between the first rocker and the second rocker increases, and the second rocker pushes the support to slide in the plug sleeve.

2. The travel adapter according to claim 1, wherein the telescopic assembly comprises a first rack, a second rack, and a gear; the gear is rotatably mounted within the plug sleeve, the first rack is mounted within the housing and extends in a sliding direction of the plug sleeve, the second rack is mounted to the support and extends in the sliding direction of the plug sleeve, and the first rack and the second rack are engaged on opposite sides of the gear.

3. The travel adapter according to claim 1, wherein the push tab comprises a handle and a strut connected, the handle is located outside the housing, the strut is slidably mounted on the plug sleeve in an X-axis direction, a first limiting protrusion is provided on the strut, a first limiting portion extending in the Z-axis direction is provided in the housing, the first limiting portion is provided with a first limiting groove and a second limiting groove, and when the second live wire plug pin and the second neutral wire plug pin extend out of the plug sleeve, the first limiting protrusion abuts against and within the first limiting groove; and when the second live wire plug pin and the second neutral wire plug pin are received in the plug sleeve, the first limiting protrusion abuts against and within the second limiting groove.

4. The travel adapter according to claim 3, wherein the push tab is further provided with a second limiting portion extending in the Z-axis direction, the second limiting portion being connected to the strut; the second limiting portion is provided with a third limiting groove and a fourth limiting groove, and the support is provided with a second limiting protrusion; when the second live wire plug pin and the second neutral wire plug pin extend out of the plug sleeve, the second limiting protrusion abuts against and within the third limiting groove; and when the second live wire plug pin and the second neutral wire plug pin are received in the plug sleeve, the second limiting protrusion abuts against and within the fourth limiting groove.

5. The travel adapter according to claim 4, wherein the support is provided with an avoidance hole for avoiding the second limiting portion.

6. The travel adapter according to claim 3, wherein an end of the strut away from the handle is sleeved with a compression spring, the compression spring being connected to the plug sleeve.

7. The travel adapter according to claim 4, wherein an end of the strut away from the handle is sleeved with a compression spring, and the compression spring is connected to the plug sleeve.

8. The travel adapter according to claim 3, wherein an outside wall of the plug sleeve is further provided with an avoidance groove extending in the Z-axis direction, and at least a portion of the first limiting portion is located within the avoidance groove.

9. The travel adapter according to claim 1, wherein a guide slide extending in the Z-axis direction is provided within the housing, and the plug sleeve is slidably mounted to the guide slide.
